(19) United States
(12) Patent Application Publication
(10) Pub. No.: US 2005/0152334 A1
(43) Pub. Date: Jul. 14, 2005

(54) Data protecting apparatus and image forming apparatus

(76) Inventors: Yuji Okamoto, Souraku-gun (JP); Katsuyoshi Fujiwara, Osaka (JP); Naofumi Ueda, Souraku-gun (JP); Syoichirou Yoshiura, Ikoma-gun (JP)

Correspondence Address: MARK D. SARALINO (GENERAL);RENNER, OTTO, BOISELLE & SKLAR, LLP, 1621 EUCLID AVENUE, NINETEENTH FLOOR, CLEVELAND, OH, 44115-2191, US

(21) Appl. No.: 11/006,992

(22) Filed: Dec. 8, 2004

(30) Foreign Application Priority Data
Dec. 11, 2003 (JP) 2003-413853

(51) Int. Cl. H04L 12/28

(52) U.S. Cl. 370/351

(57) ABSTRACT

To provide a data protecting apparatus and an image forming apparatus capable of providing an operating environment to make a user aware of protection of data. When turning on power of the image forming apparatus, a system is checked, and whether or not a security kit is mounted on a ROM mounting part, or whether or not the security function is made effective, is determined. When it is determined that the security kit is mounted, or the security function is made effective, an electronic mail address of a device manager is received by starting a notifying destination setting mode and displaying a notifying destination setting screen on a display part. When it is determined that the received address can be accepted as a notifying destination and can be accepted as a transmitting destination, a security program is executed by unloading such a program from the security kit mounted on the device. Or by using the security function made effective, the security kit or the security function made effective is set in operable state.

### CROSS-REFERENCE TO RELATED APPLICATION

This Nonprovisional application claims priority under 35 U.S.C. §119(a) on Patent Application Ser. 2003-413853 filed in Japan on Dec. 11, 2003, the entire contents of which are hereby incorporated by reference.

### BACKGROUND OF THE INVENTION

The present invention relates to a data protecting apparatus and an image forming apparatus capable of providing an operating environment to make a user aware of a protection of data.

Conventionally, an image forming apparatus provided with an electronic filing function to read documents to be copied as image data by optically scanning them, temporarily store the image data in a storage medium, read-out the image data of an arbitrary document from the storage medium by repeating the number of times corresponding to desired copies, and print out the read image data out on copying paper, is known (For example, see Japanese Patent Laid Open No. Hei 06-178041).

In the provided image forming apparatus with the electronic filing function, for example, FAT (File Allocation Table) controls a designation of a storage position on the storage medium when storing the image data, and the designation of the storage position on the storage medium when reading-out the image data, and so forth. According to the FAT, the information number is allocated for every information to be stored in the storage medium, and by this information number, a reference value of the FAT is determined. Based on the reference value of the determined FAT, the storage position of each image data on the storage medium is specified. The FAT is updated every time the printout of the image data, which is a subject of control, is completed. Moreover, by erasing or updating the contents of the FAT, it becomes impossible for the image forming apparatus to read-out the image data stored in the storage medium specified by the FAT. Accordingly, by using the FAT, the danger of information leaks is reduced, and the security of the image data can be ensured.

However, with developing and spreading of information processing technology of recent years, even when the contents of the FAT is erased or updated, there is a possibility that the storage medium itself is removed and taken out from the apparatus by an ill-intentioned third party, for example, and the image data stored therein is read-out and obtained illegally, if the image data itself stored in the storage medium (or example, hard disk) is not erased.

Therefore, in order to ensure the security of the image data against the information leaks and illegal use, a security kit is commercialized. In the security kit, the information leaks or the illegal use of the image data from the electronic filing function is prevented by erasing and encrypting the image data and by erasing the image data stored in a memory. Such a security kit can be applied to the aforementioned electronic filing function, and also can be attached not only to the image forming apparatus having such an electronic filing function but also to various devices afterwards, so to speak. In addition, the aforementioned security function may be incorporated in each device and made effective if necessary, to thereby set the device capable of using the security function in case of necessity.

Meanwhile, the image forming apparatus is suggested, in which when troubles such as paper jamming are generated, or when the consumable article such as a toner cartridge or paper, or the like is consumed, an electronic mail including the above-described message is created and transmitted to a prescribed electronic mail address such as a device manager or the like, so as to notify the device manager of the trouble generated and the replacement time of the consumable article.

In such an image forming apparatus, the device manager can also be notified of access conditions to data stored in the storage medium. For example, when the data is transmitted to the outside by using the electronic filing function, by noting the device manager accordingly, the information leaks and the illegal use of the image data can be monitored.

### BRIEF SUMMARY OF THE INVENTION

In view of the above-described circumstances, the present invention is provided. An object of the present invention is to provide a data protecting apparatus and an image forming apparatus, comprising a data protecting section for data already received, and an information generating section to generate the information to be reported to the outside, wherein the information on a transmitting destination of the information to be reported is acquired when the protection of data is possible, and when the information on the transmitting destination is acquired, the protection of the data is started by the data protecting section, to allow the data protecting apparatus to adequately use a protecting function of the data mounted thereon and further enhance a data protecting performance.

A first aspect of the present invention provides a data protecting apparatus, comprising: means for receiving data; means for protecting the received data; means for generating information to be reported to outside;

means for transmitting the generated information; means for acquiring the information on a transmitting destination of the information, in the case for protecting of the data by said means; and means for controlling the operation of said means so as to start the protection of the data, in the case for acquiring the information on the transmitting destination.

According to the first aspect of the present invention, the data protecting apparatus comprises means for protecting the received data, and means for generating the information to be reported to outside, wherein when protecting the data is possible, the information on the transmitting destination of the information to be reported is acquired, and when the information on the transmitting destination is acquired, the protection of the data is started by said means. Therefore, a required condition for starting the protection of the data is to set the transmitting destination of the information to be reported to outside. The means for protecting data is thereby prohibited from operating individually.

A second aspect of the present invention provides the data protecting apparatus, further comprising means for verifying a presence of the transmitting destination based on the information on the transmitting destination acquired by said means.

According to the second aspect of the present invention, the presence of the transmitting destination is verified based on the. information received as the transmitting destination of the information to be reported. Therefore, a dummy transmitting destination is prevented from being received, and it becomes possible to reliably set the transmitting destination.

A third aspect of the present invention provides the data protecting apparatus, comprising: means for transmitting a request information to request a response to the transmitting destination; means for receiving a response information transmitted to the request information; and means for determining whether or not the response information is received by said means, wherein based on a determination result of said means, the presence of the transmitting destination is verified.

According to the third aspect of the present invention, the request information requesting the response to the transmitting destination is transmitted, and the presence of the transmitting destination is verified depending on whether or not the response information transmitted to the request information is received. Therefore, the dummy transmitting destination is prevented from being received, and it becomes possible to reliably set the transmitting destination.

A fourth aspect of the present invention provides the data protecting apparatus, wherein the information on the transmitting destination serves as the information to designate a transmission range.

According to the fourth aspect of the present invention, the information to designate the transmission range is received as the information on the transmitting destination. Therefore, for example, the transmitting destination of the information to be reported is limited, by setting a domain name in Internet Communication.

A fifth aspect of the present invention provides the data protecting apparatus, wherein the information on the transmitting destination serves as the information to identify the apparatus of the transmitting destination.

According to the fifth aspect of the present invention, by receiving the information to identify the apparatus as the information on the transmitting destination, the transmitting destination of the information to be reported is limited to a specific device.

A sixth aspect of the present invention provides the data protecting apparatus, wherein the information on the transmitting destination is an electronic mail address.

According to the sixth aspect of the present invention, by receiving the electronic mail address as the information on the transmitting destination, the transmitting destination of the information to be reported is limited to a specific electronic mail address.

A seventh aspect of the present invention provides an image forming apparatus, comprising: means for receiving image data; means for forming an image on a sheet based on the received image data; means for protecting the image data; means for generating the information to be reported to outside; means for transmitting the generated information;

means for acquiring the information on the transmitting destination of the information, in case for protecting the image data by said means; and means for controlling an operation of said means so as to start the protection of the image data in case for acquiring the information on the transmitting destination.

According to the seventh aspect of the present invention, the image forming apparatus comprises: means for protecting the received image data; and means for generating the information to be reported to outside, wherein the information on the transmitting destination of the information to be reported is acquired in case that protecting the received image data is possible, and in case for acquiring the information on the transmitting destination, protection of the image data is started by said means. Therefore, the required condition for starting the protection of the data is to set the transmitting destination of the information to be reported to outside, and said means for protecting image data is thereby prohibited from operating individually.

An eighth aspect of the present invention provides the data protecting apparatus, comprising a processor capable of performing operations for receiving data; generating information to be reported to outside; transmitting the generated information; acquiring the information on the transmitting destination of the information in case that protecting the received data is possible; and starting protection of the data in case that the information on the transmitting destination is acquired.

According to the eighth aspect of the present invention, when the protection of the received data is possible, the information on the transmitting destination of the information to be reported is acquired, and when the information on the transmitting destination is acquired, the protection of the data is started by said means. Therefore, the required condition for starting the protection of the data is to set the transmitting destination of the information to be reported to outside, and the data protecting section is thereby prohibited from operating individually.

A ninth aspect of the present invention provides the data protecting apparatus, comprising a processor capable of performing operations of verifying a presence of the transmitting destination based on the information on the acquired transmitting destination.

According to the ninth aspect of the present invention, the presence of the transmitting destination is verified based on the information received as the transmitting destination of the information to be reported. Therefore, the dummy transmitting destination is prevented from being received, and it becomes possible to reliably set the transmitting destination.

A tenth aspect of the present invention provides the data protecting apparatus, comprising a processor capable of performing operations of transmitting a request information to request a response to the transmitting destination; receiving the response information transmitted to the request information; determining whether or not the response information is received; and verifying a presence of the transmitting destination based on a determination result.

According to the tenth aspect of the present invention, the request information to request the response to the transmitting destination is transmitted, and the presence of the transmitting destination is verified depending on whether or not the response information transmitted to the request information is received. Therefore, the dummy transmitting destination is prevented from being received, and it becomes possible to reliably set the transmitting destination.

An eleventh aspect of the present invention provides the image forming apparatus, which forms an image on a sheet based on the received image data, comprising a processor capable of performing operations of receiving image data; protecting the image data; generating information to be reported to outside; and transmitting the generated information, wherein in protecting the data, the information on the transmitting destination of the information to be reported is received, and when the information is received, the protection of the image data is started.

According to the eleventh aspect of the present invention, when the received image data is protected, the information on the transmitting destination of the information to be reported is received, and when the information on the transmitting destination is thus received, the protection of the image data is started. Therefore, the required condition for starting the protection of the image data is to set the transmitting destination of the information to be reported to the outside, and the protection of the image data is thereby prohibited from being performed individually.

According to the data protecting apparatus of the present invention comprises means for protecting received data, means for generating the information to be reported to outside, wherein in protecting the received data, the information on the transmitting destination of the information to be reported is received and the protection of the data is started by said means in case that the information on the transmitting destination is received. Therefore, the required condition for starting the protection of the data by said means is to set the transmitting destination of the information to be reported to outside, and said means is thereby prevented from operating individually. As a result, the combination of the means for protecting data and the means for transmitting information to be reported allows the protecting function of the data to be further enhanced.

According to the data protecting apparatus of the present invention, the presence of the transmitting destination is verified based on the information received as the transmitting destination of the information to be reported. Therefore, the dummy transmitting destination, etc, is prevented from being received, and it becomes possible to reliably set the transmitting destination.

According to the data protecting apparatus of the present invention, the request information to request the response to the transmitting destination is transmitted, and the presence of the transmitting destination is verified according to whether or not the response information transmitted to the request information is received.

Therefore, the dummy transmitting destination is prevented from being received, and it becomes possible to reliably set the transmitting destination.

According to the data protecting apparatus of the present invention, the information to designate the transmission range is received as the information on the transmitting destination. Therefore, for example, the transmitting destination of the information to be reported can be limited by setting a domain name in Internet Communication, and the information leaks can be prevented.

According to the data protecting apparatus of the present invention, the information to identify the apparatus as the information on the transmitting destination is received. Therefore, the transmitting destination of the information to be reported is limited to a specific device, and the information leaks can be prevented.

According to the data protecting apparatus of the present invention, the electronic mail address is received as the information on the transmitting destination. Therefore, the transmitting destination of the information to be reported is limited to a specific electronic mail address, and the information leaks can be prevented.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view explaining the whole structure of an image forming system constructed by an image forming apparatus according to this embodiment.

FIG. 2 is a block diagram explaining a structure of a control system of the image forming apparatus.

FIG. 3 is a conceptual diagram showing an example of a system management table.

FIG. 4 is a flow chart explaining a procedure of processing executed by the image forming apparatus at turning on power.

FIGS. 5A and 5B are schematic views showing an example of a screen displayed on a display part in a notifying destination setting mode.

FIGS. 6A through 6C are schematic views showing an example of each kind of message screen displayed on the display part.

FIG. 7 is a schematic view showing an example of a setting screen to set information contents.

FIG. 8 is a conceptual diagram showing an example of a notifying destination managing table.

FIG. 9 is a flowchart explaining a procedure of processing to execute, when an electronic mail attached with warning information is transmitted from the image forming apparatus.

FIG. 10 is a flowchart explaining the procedure of the processing executed by the image forming apparatus at turning on power.

### DETAILED DESCRIPTION OF THE INVENTION

As described above, various functions are loaded on an image forming apparatus, including the function capable of adding a data protecting function by attaching the aforementioned security kit afterward, or the function capable of making the security function effective by incorporating the security function that can be provided by the security kit, and the function capable of reporting various kinds of information such as trouble occurrence, consumption state of consumable articles, and utilization of an electronic filing function and so forth by electronic mail. In this state, preferably an electronic mail address, which is a notifying destination of each kind of information, is reliably set, when the security kit is attached afterwards, or the security function incorporated therein is made effective. Specifically, when the security kit is added, or when the security function incorporated therein is made effective, it can be so considered that a security environment of data is needed on the side of a user. Therefore, it is desirable to provide an environment, under which information leaks and an illegal use of the image data can be monitored, by reporting the utilization, etc, of the electronic filing function as needed.

However, conventionally such functions are loaded on the image forming apparatus as an independent function respectively. Therefore, a problem is that in some cases, the notifying destination of the utilization of the aforementioned electronic filing is not set even when the data can be protected by adding the security kit or making the security function incorporated therein effective, and therefore the protecting function of data already loaded thereon is not allowed to be adequately utilized.

In addition, the same problem is involved when the user does not know the presence of the notifying function of information, and does not set the notifying destination, thinking it troublesome.

In view of the above-described circumstances, the present invention is provided. An object of the present invention is to provide a protecting apparatus and an image forming apparatus, comprising: a data protecting section for the data already received; and an information generating section to generate the information to be reported to the outside, wherein in protecting the data thus received, the information on a transmitting destination of the information to be reported is received, and when the information on the transmitting destination is received, the protection of the data is started by the data protecting section, to thereby adequately utilize the protecting function of the data loaded thereon and further enhance the protecting performance of the data.

Hereafter, preferred embodiments of the data protecting apparatus according to the present invention applied to the image forming apparatus such as a printer, a digital composite machine, and so forth, will be specifically explained by using the drawings.

Embodiment 1

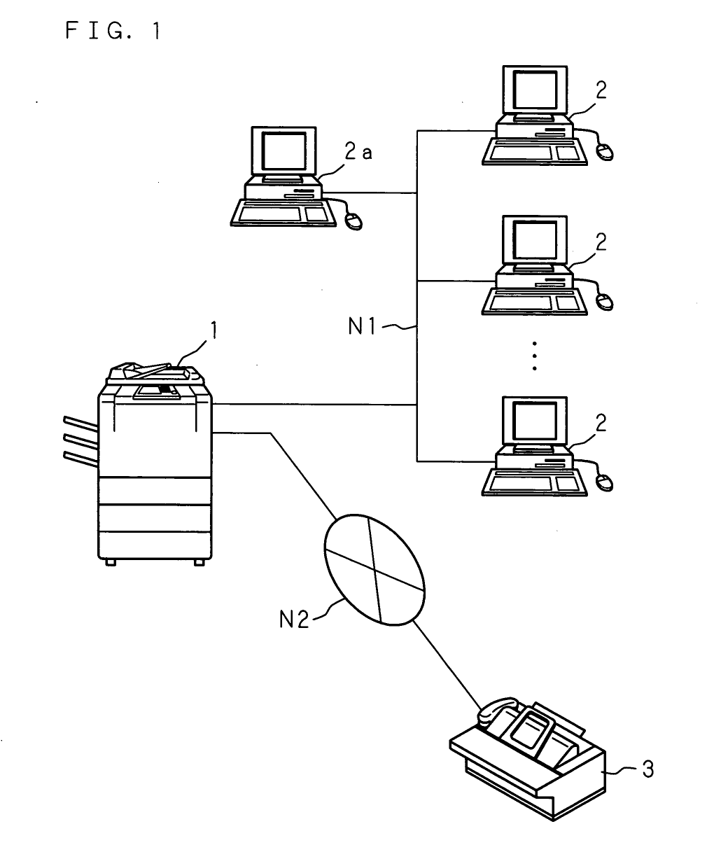

FIG. 1 is a schematic view explaining the whole structure of the image forming system constructed by the image forming apparatus according to this embodiment. Reference numeral 1 in the figure indicates the image forming apparatus having a printer function, a copying function, a scanner function, and a facsimile function. Wherein, information processors 2, 2, . . . , 2, such as a personal computer and a work station and an information processor 2a of the image forming apparatus 1 used by a device manager are connected to an image forming apparatus 1 through a communication network N1, and an external facsimile device 3 is connected thereto through a facsimile communication network N2. A driver program (printer driver) for using the image forming apparatus 1 via the communication network N1 is previously installed on the information processor 2. Then, a print job is generated by the printer driver, and the print job thus generated is transmitted to the image forming apparatus 1, to thereby execute printing processing. Also, the image forming apparatus 1 comprises a section to encode and decode facsimile data transmitted via the facsimile communication network N2. The facsimile data thus encoded is transmitted to the facsimile device 3, and the facsimile data thus transmitted from the facsimile device 3 is received. Thereafter, the printing processing is executed based on the image data obtained by decoding the facsimile data thus received.

Further, the image forming apparatus 1 has a document filing function capable of storing the image data and so forth developed from the received print job, and the image data and so forth acquired by an image reading part as will be described later in an nonvolatile storage section, then capable of output processing by reading-out the image data from the storage section as needed. Namely, the image forming apparatus 1 can be used as an image server on the communication network N1.

According to the image forming apparatus 1 of this embodiment, as will be described later, when the function to protect data is added to the image forming apparatus 1, or the function to protect the data incorporated therein is made effective, the transmitting destination of various kinds of warning information to be reported from the image forming apparatus 1 is urged to be set. The warning information reported from the image forming apparatus 1 includes the information on the replacement time of the consumable articles such as paper jamming, shortage of toner, shortage of paper, a serviceman call, and a maintenance call, the information on troubles occurred to the image forming apparatus 1. In addition, when there arises an access request to the stored data (referred to as filing data hereafter) by using a document filing function, the warning information reports accordingly. In the image forming apparatus 1, when the notifying destination of such a warning information is set, the protecting function of the data is operated. In other words, the notifying destination of the warning information is required to be set to cause the data protecting function to be operated, and the image forming apparatus is capable of providing an environment to make a user (device manager) aware of the protection of the data.

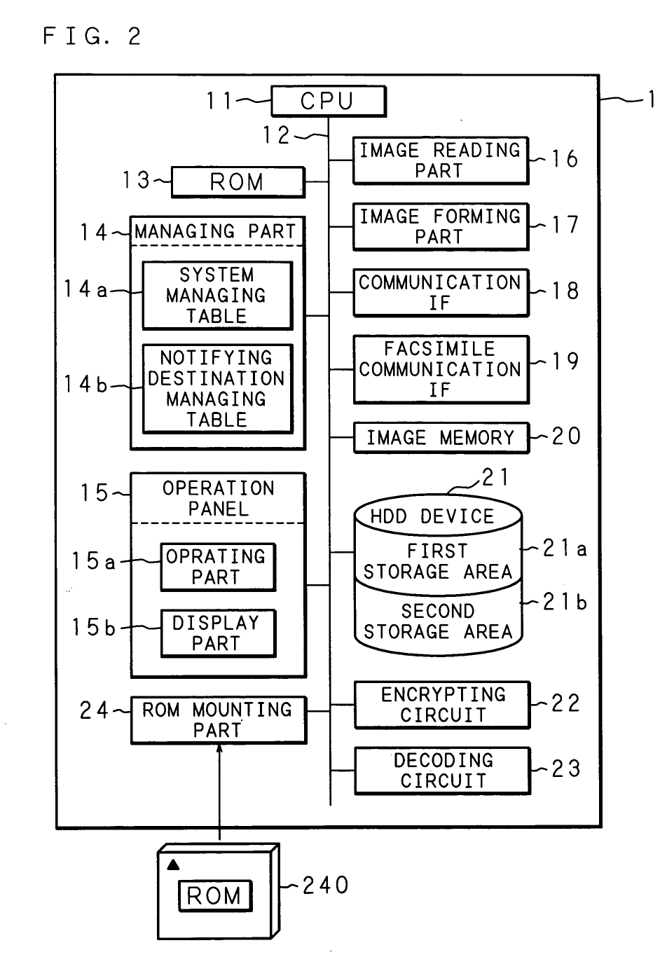

FIG. 2 is a block diagram explaining the structure of a control system of the image forming apparatus 1. The image forming apparatus 1 comprises a CPU 11. The CPU 11 reads out a control program previously stored in a ROM 13, executes the control program thus read-out, controls each kind of hardware connected thereto via a bus 12, and causes the hardware to operate as a device executing the aforementioned processing in its entirety. A managing part 14 is composed of semiconductor memory, and a part of the storage region is utilized as a system managing table 14a and a notifying destination managing table 14b. The system managing table 14a manages the information on the structure of the hardware loaded on the image forming apparatus 1, and the information on the operation state of the hardware. The CPU 11 of the image forming apparatus 1 acquires the information of the hardware loaded thereon by communicating with each hardware at turning on power, and monitors the condition of each hardware on a steady bases during operation, and when there is a change in the operation state, updates the contents of the table. In the notifying destination managing table 14b, the notifying destination of the aforementioned warning information is stored in association with the contents to be reported to each notifying destination. Therefore, when troubles and an event such as an access to filing data arise, the information of the notifying destination to report the information of the associated event is acquired by referring to the information of the notifying destination managing table 14b, and the electronic mail is created and transmitted to the notifying destination thus acquired.

An operation panel 15 is composed of an operating part 15a where operating instruction of a user is received, and a display part 15b where the information to be reported to the user is displayed. The operating part 15a is equipped with each kind of operating key for receiving the operating instruction from the user, and receives the instruction of the user to a setting value, switching operation, and output start instruction or the like of each function such as the number of print sheets, copy density, and the transmitting destination of facsimile data. The display part 15b is equipped with liquid crystal display where the operation state of the image forming apparatus 1, each kind of setting value inputted through the operating part 15a, and a guide screen notifying the user of the operating guide, and so forth are displayed. In addition, a part of the display part 15b is equipped with software keys of a touch panel system formed in such a way as to receive the aforementioned setting operation.

An image reading part 16 is equipped with a light source irradiating a document for reading with light, an image sensor such as a CCD (Charge Coupled Device), and an AD converter (not shown). Then, an image of the document set in a prescribed reading position is formed on the image sensor, and converted into an analog electric signal, and the analog signal is A/D converted. Then, a digital signal obtained by A/D conversion is corrected in light distribution of the light source at reading of the document and sensitivity unevenness of the image sensor or the like, and the image data in digital form is thereby generated.

An image forming part 17 is equipped with a charger electrifying a photoreceptor drum to a prescribed potential, a laser writing device generating an electrostatic latent image on the photoreceptor drum by radiating a laser light according to the image data received from the outside, a developing unit visualizing the electrostatic latent image formed on a surface of the photoreceptor drum by supplying toner, and a transfer unit transferring a toner image formed on the photoreceptor drum on a sheet such as an OHP film (not shown), and an image desired by the user can be formed on paper by an electrophotographic system.

Note that although in this embodiment, the image forming part 17 forms an image by the electrophotographic system using a laser writing device, needless to say, the image may also be formed by an inkjet system, a thermal transfer system, and a sublimatic system.

Communication IF18 is provided with a communication interface based on a communication standard of the communication network N1, and receives the print job from the information processors 2, 2, . . . , 2 connected to the communication network N1, and transmits the information to be reported to the information processors 2, 2, . . . , 2. In addition, when the image forming apparatus 1 is used as a so-called network scanner, the image data of the document obtained by the image reading part 16 is transmitted to a desired information processor 2 through the communication IF 18. In the communication IF18, such a sending and receiving of each kind of data is controlled.

A facsimile communication IF19 is provided with a line terminating circuit for connecting the facsimile device to the outside, and receives the facsimile data transmitted via the facsimile communication network N2. The facsimile communication IF19 is provided with a decoding circuit for decoding the received facsimile data, and transfers the image data thus obtained by decoding to an image data memory 20. Also, the facsimile communication IF19 is provided with an encoding circuit for encoding the facsimile data to be transmitted, and transmits the facsimile data thus encoded by the encoding circuit to a target facsimile device. The facsimile communication IF19 thus transmits and receives the facsimile data and executes the encoding and decoding processing of the facsimile data.

The image memory 20 is composed of semiconductor memory, and temporarily stores the image data generated by reading the image of the document by the image reading part 16, and the image data developed from the print job received through the communication IF18, and the image data developed from the facsimile data received through the facsimile communication IF19. The image data thus temporarily stored in the image memory 20 is transferred to a transfer destination corresponding to a purpose of utilization by the instruction of the CPU11.

Specifically, when the image is formed on paper, the image data is transferred to the image forming part 17, and when transmitted to the information processor 2 as scanner data, the image data is transferred to the communication IF18, and when transmitted as facsimile data, the image data is transferred to the facsimile communication IF19, and when saved by using the document filing function, the image data is transferred to an HDD device 21.

The HDD device 21 is a disk-like magnetic recording medium, and a part of the storage area is used as a data storage area for storing the image data. Then, when the request is received through the operation panel 15, or when the request transmitted from the information processor 2 is received via the communication IF18, the image data stored in the data storage area is read-out. Therefore, when the print processing needs to be executed again due to the failure of print processing or shortage of the number of outputs, the print processing can be executed by arbitrarily reading-out the image data stored in the data storage area.

The data storage area is separated into a first storage area 21a and a second storage area 21b, and the capacity of the first storage area 21a is set to be smaller than that of the second storage area 21b. Therefore, the first storage area 21a is used as the area for temporarily storing the data, and when the free capacity of the first storage area 21 a becomes small, the data after a predetermined time passes from being stored in the first storage area 21a is automatically stored in the second storage area 21b. Meanwhile, the second storage area 21b stores the data by arranging them by file format, by processing modes such as a printer function, a scanner function, a copying function, and a facsimile function, or by folder created by the user. In this state, if an operating instruction such as erasing is not given, the data is saved. When the loss of free capacity of the second storage area 21b occurs, the loss of free capacity is accordingly displayed on the display part 15b of the operation panel 15 and reported to the user. Then, by eliminating the data determined to be unnecessary, or additionally installing the HDD device, new free capacity is urged to be ensured. Note that the first storage area 21a is referred to as a work area 21a, and the second storage area 21b is referred to as a filing area 21b.

An encrypting circuit 22 comprises an inputting buffer to input data to be encrypted, an arithmetic unit to carry out a predetermined calculation for the data set by the inputting buffer, and an outputting buffer to hold an arithmetic result obtained by the arithmetic unit. In the calculation performed by the arithmetic unit, a known encrypting algorithm such as a DES system (DES: Data Encryption Standard) and a 3DES system and so forth can be used. In the encrypting processing using the DES system, first, the data to be encrypted is broken down into blocks of 64 bits, and the data is inputted in the inputting buffer of the encrypting circuit 22 for each block. Then, the inputed data set in the inputting buffer is taken out, and the arithmetic unit carries out arithmetic processing for the data thus taken out. Then, in the stage of completing the arithmetic processing, the arithmetic result is written in the outputting buffer. The CPU11 of the image forming apparatus 1 subsequently sets the data for each block in the inputting buffer in a proper timing, and by taking out the data, of which the arithmetic processing is completed, from the outputting buffer, the decoding circuit 22 acquires the encrypted data.

The decoding circuit 23 is basically constituted in the same way as the encrypting circuit 22, and comprises the inputting buffer to input the data to be subjected to decoding processing, the arithmetic unit to perform a prescribed arithmetic processing to the data set in the inputting buffer, and the outputting buffer to hold the arithmetic result obtained by the arithmetic unit. The arithmetic unit is capable of calculating by the known decoding algorithm such as the aforementioned DES system and the 3DES system. The CPU11 of the image forming apparatus 1 subsequently sets the data for each block in the inputting buffer in a proper timing, and by taking out the data, of which the arithmetic processing is completed, from the outputting buffer, the decoding circuit 23 acquires the decoded data.

Note that needless to say, the systems of the encrypting processing by the encrypting circuit 22 and the decoding processing by the decoding circuit 23 are not limited to the aforementioned DES system and 3DES system. Moreover, encrypting and decoding are not necessarily required to be performed by processing of the hardware. For example, the computer program to encrypt and decode is previously stored in an ROM13, and by the processing of the program thus stored, the encrypting and the decoding may be performed.

Further, the image forming apparatus 1 according to this embodiment is equipped with an ROM mounting part 24 on which an ROM240 storing the computer program to add the data protecting function is mounted (referred to as security kit 240 hereafter). After turning on the power of the image forming apparatus 1, when the CPU11 detects the security kit 240 mounted on the ROM24 by downloading and executing the computer program (referred to as security program hereafter) stored in the security kit 240, the processing of data protection is performed. That is, by erasing the data already processed and temporarily stored in a work area 21a and encrypting the data saved in the filing area 21b, the protection of the data to be handled in the inside of the image forming apparatus 1 is performed.

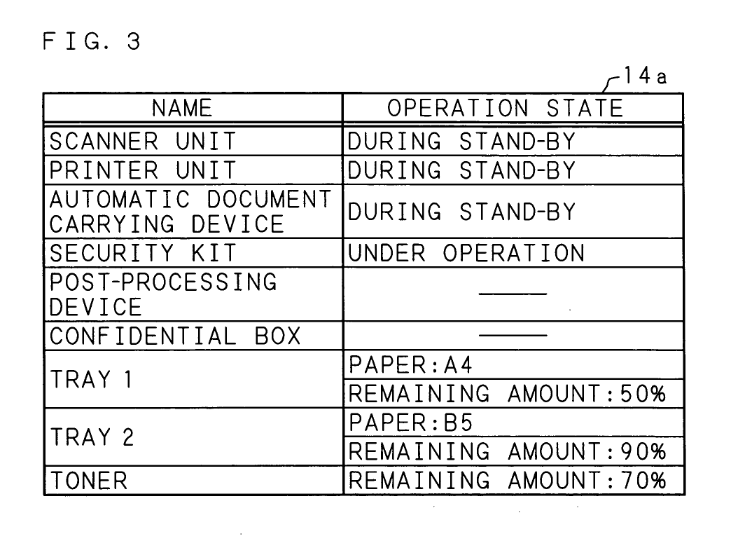

FIG. 3 is a conceptual diagram showing an example of the system managing table 14a. As described above, the image forming apparatus 1 has the system managing table 14a for managing the operation state of the hardware loaded thereon, and the name of the hardware mounted thereon or the hardware capable of being loaded thereon is stored in association with the operation state of the hardware loaded thereon. In the example shown in FIG. 3, a scanner unit (image reading part 16) to read the image of the document, and a printer unit (image forming part 17) to execute the print processing on paper are loaded on the image forming apparatus 1, and at the present time, such units are in standby position. Meanwhile, FIG. 3 shows that a post-processing device to apply post-processing to printed paper, and a confidential box to discharge confidentially processed paper are not loaded. Further, FIG. 3 shows that the security kit 240 is loaded and the security kit 240 is already started.

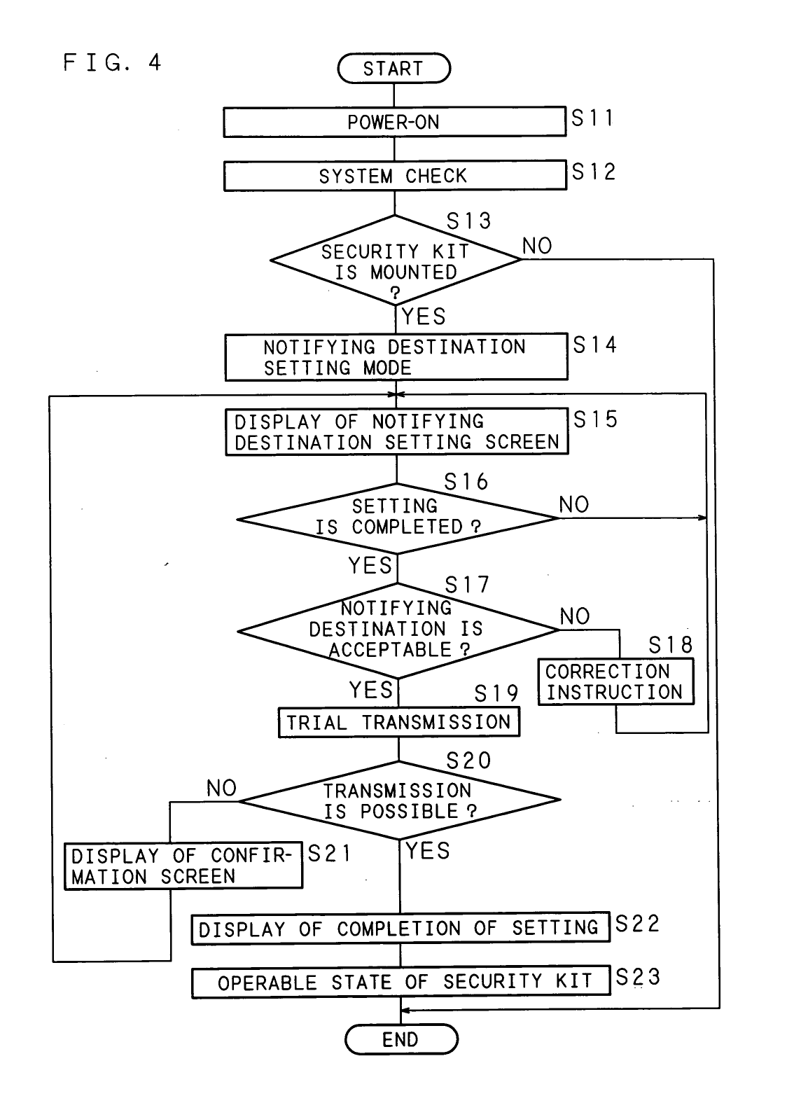

FIG. 4 is a flow chart explaining the procedure of the processing executed by the image forming apparatus 1 at turning on power. When the power is turned on to supply the power to each part of the hardware constituting the image forming apparatus 1 (step S11), first, the CPU11 of the image forming apparatus 1 checks the system (step S12). Specifically, the CPU11 communicates with each part of the hardware connected thereto via the bus 12, detects whether or not the hardware is loaded or not loaded, detects the operation state of the hardware loaded thereon, and executes the processing of registering the information in the system managing table 14a.

Next, the CPU11 of the image forming apparatus 1 determines whether or not the security kit 240 is mounted on the ROM mounting part 24 by referring to the information thus registered in the system managing table 14a (step S13). When the CPU11 of the image forming apparatus 1 determines that the security kit 240 is not mounted on the ROM mounting part 24, as a result of referring to the system managing table 14a (step S13: NO), the processing by this routine is ended.

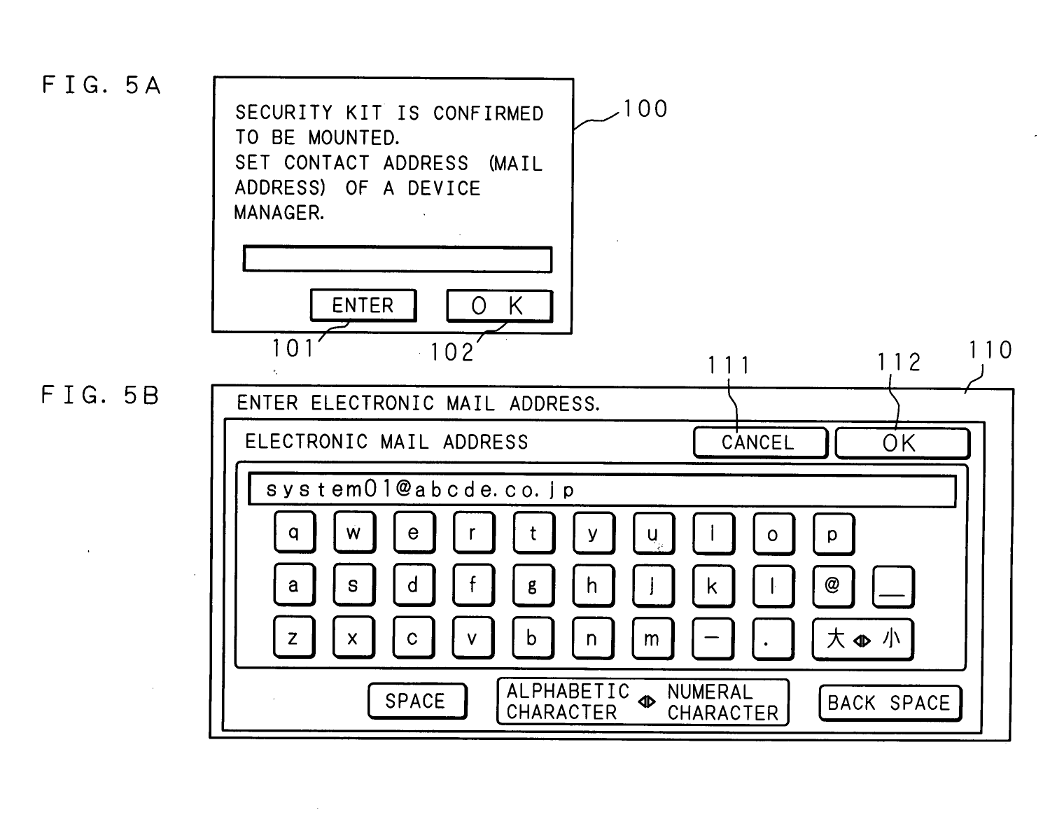

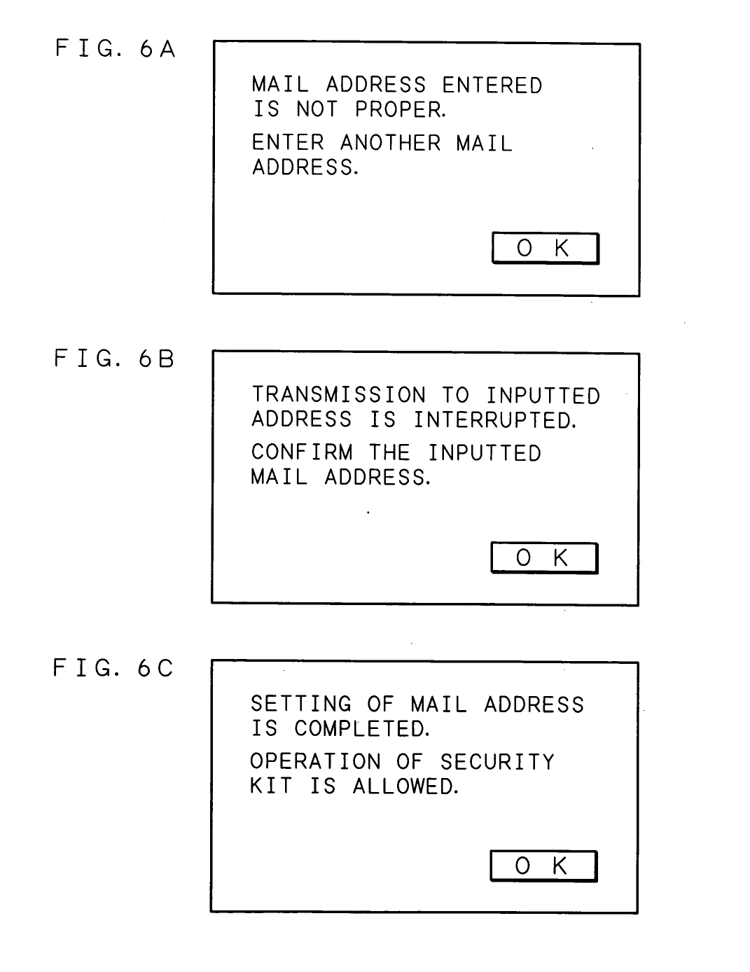

Meanwhile, when the CPU11 of the image forming apparatus 1 determines that the security kit 240 is mounted on the ROM mounting part 24, as a result of referring to the system managing table 14a (step S13: YES), a notifying destination setting mode to set the notifying destination of the aforementioned warning information is started (step S14), and a notifying destination setting screen is displayed on the display part 15b of the operation panel 15 (step S15). FIGS. 5A and 5B are schematic views showing an example of the screen displayed on the display part 15b in the notifying destination setting mode, and FIGS. 6A through 6C are schematic views showing an example of the screen of each kind of message displayed on the display part 15b. When the notifying destination setting mode is started, first, a notifying destination setting screen 100 as shown in FIG. 5A is displayed on the display part 15b. The notifying destination setting screen 100 displays to the effect that the security kit 240 is mounted, and to the effect that the contact address (electronic mail address) of the device manager should be displayed, and an input button 101 and a determination button 102 composed of software keys are displayed. When the input button 101 is depressed for inputting the contact address of the device manager, an electronic mail input screen 110 as shown in FIG. 5B is displayed on the display part 15b.

The electronic mail input screen 110 is equipped with software keys such as alphabetic character keys, a space key, an alpha-numeral switching key, and a backspace key, to which alphabet and each kind of symbol are entered. Then, the electronic mail can be inputted by using such keys in combination. In this electronic mail input screen 110, when a cancel key 111 is depressed, the inputted electronic mail is not determined but returned to the notifying destination setting screen 100, and when a determination button 112 is depressed, the inputted electronic mail is determined and returned to the notifying destination setting screen 100.

Next, the CPU11 determines whether or not setting of the electronic mail address of the device manager is completed, by determining whether or not the determination button 102 is depressed in the notifying destination screen 100 (step S16). When the above-described setting is determined not to be completed (step S16: NO), the processing is returned to step S15. Then, when the above-described setting is determined to be completed (step S16: YES), the CPU11 determines whether or not the electronic mail address set in the notifying destination screen 100 can be accepted as the notifying destination (step S17). When it is determined that the inputted address does not meet the format of the electronic mail address, or the inputted address is a dummy electronic mail address (for example, xxx@xxx. jp, etc), the CPU11 determines that the electronic mail address already set is not accepted as the notifying destination (step S17: NO). Then, a message screen as shown in FIG. 6A is displayed on the display part 15b, and an instruction to correct the electronic mail address is given (step S18). Then, the processing is returned to step S15, the notifying destination setting screen 100 is displayed again, and re-setting of the electronic mail address is urged.

In step S17, when the CPU11 determines that the electronic mail address set in the notifying destination setting screen 100 can be accepted as the notifying destination (step S17: YES), trial transmission to the electronic mail address thus accepted is performed (step S19), and whether or not such an electronic mail address can be accepted is determined (step S20). After the trial transmission, when it is determined that error message is returned from a domain name server not shown, the CPU11 determines that the above electronic mail address is not accepted as a transmitting destination (step S20: NO). Then, a confirmation screen as shown in FIG. 6B is displayed on the display part 15b (step S21), and the processing is returned to step S15. In the step S15, the notifying destination setting screen 100 is displayed again and the re-setting of the electronic mail address is urged.

Meanwhile, after the trial transmission, when the error message is not returned from the domain name server within a prescribed time, the electronic mail address already set is accepted as the transmitting destination (step S20: YES). Then, the message screen as shown in FIG. 6C is displayed on the display part 15b, to the effect that the setting of the electronic mail address is completed (step S22). Next, the CPU11 enables the operation of the security kit 240 (step S23). Namely, the CPU11 executes a security program stored in the security kit 240 by unloading the program.

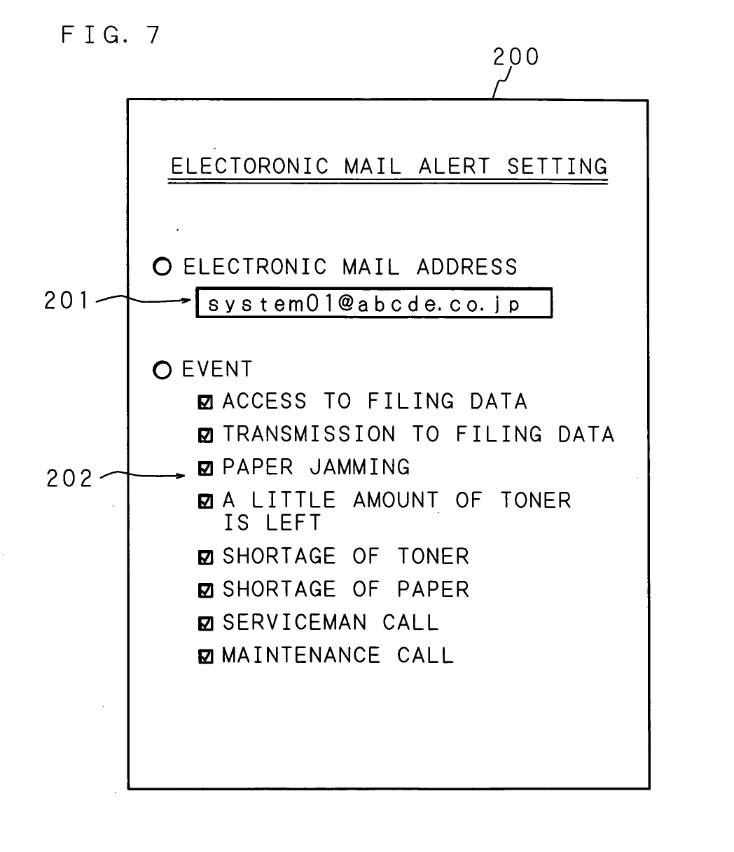

The image forming apparatus 1 of this embodiment transmits the electronic mail attached with warning information to the electronic mail address of the device manager set as described above, when events such as paper jamming, shortage of toner, shortage of paper, and access request to the filing data are generated. The contents to be reported to the device manager can be set for each electronic mail address. FIG. 7 is a schematic view showing an example of a setting screen to set the noting contents. For example, by accessing the image forming apparatus 1 through the information processor 2a used by the device manager, and by performing a prescribed operation, an alert setting screen 200 as shown in FIG. 7 can be displayed on a display part (not shown). In the alert setting screen 200 is arranged an input column 201, to which the electronic mail address of the device manager is inputted, and a check box 202 in which necessity of notification is set for each event. Thus, the event desired by the device manager to be reported can be arbitrarily set.

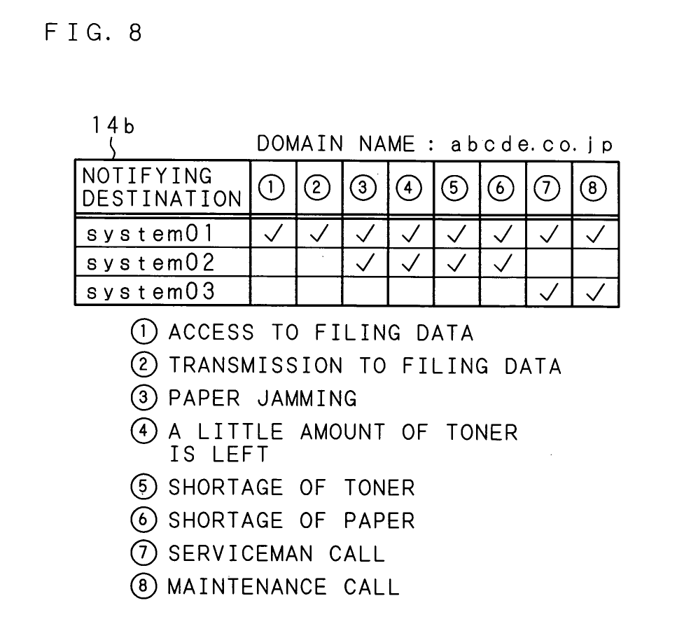

The contents set in the alert setting screen 200 are transmitted to the image forming apparatus 1, and registered in the notifying destination managing table 14b provided in the managing part 14 of the image forming apparatus 1. FIG. 8 is a conceptual diagram showing an example of the notifying destination managing table 14b. In the notifying destination managing table 14b, the notifying destination of the warning information is stored in association with the notifying contents defined for each notifying destination. For example, it is set so that the electronic mail attached with warning information for every event is transmitted to the noting destination expressed by system01@abcde.co.jp. Moreover, it is set so that the electronic mail attached with warning information is transmitted to the notifying destination expressed by “system03@abcde.cc.jp” , only when the serviceman call and the maintenance call are required.

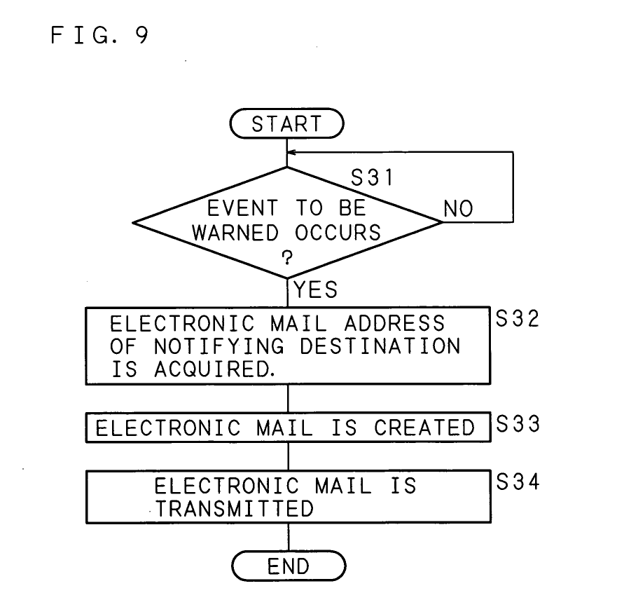

FIG. 9 is a flow chart explaining the procedure of the processing executed when the electronic mail attached with the warning information is transmitted from the image forming apparatus 1. The CPU11 determines whether or not the event to be warned occurs, according to the information registered in the system managing table 14a (step S31).

When the CPU11 determines that the event to be warned does not occur (step S31: NO), the CPU11 is set in standby until the event to be warned occurs.

When the CPU11 determines that the event to be warned occurs (step S31: YES), the electronic mail address of the noting destination is acquired, according to the contents registered in the notifying destination managing table 14b (step S32). Then, the electronic mail is automatically created including the warning message previously prepared, for transmitting to the electronic mail address already acquired (step S33), and the electronic mail thus created is transmitted through the communication IF18 (step S34).

In this embodiment, the electronic mail address of the device manager is previously registered in the notifying managing table 14b, and each kind of warning information is reported by the electronic mail.

However, the communication address (for example, IP address) of the information processor 2a used by the device manager may be previously registered as the notifying destination, and when the event to be warned occurs, the warning message may be transmitted to the communication address and directly displayed on the display part of the information processor 2a.

Embodiment 2

In the embodiment 1, by detecting whether or not the security kit 240 provided from the ROM is mounted on the ROM mounting part 24 in the image forming apparatus 1, whether or not the data protecting function is added is determined. However, the computer program (security program) according to data protection may be previously stored in a storage section (for example, ROM 13) in the device, and when receiving a prescribed operation by the device manager, the data protecting function may be added by the security program. Note that in this embodiment also, the internal structure of the image forming apparatus is the same as that of the embodiment 1, and therefore explanation is omitted.

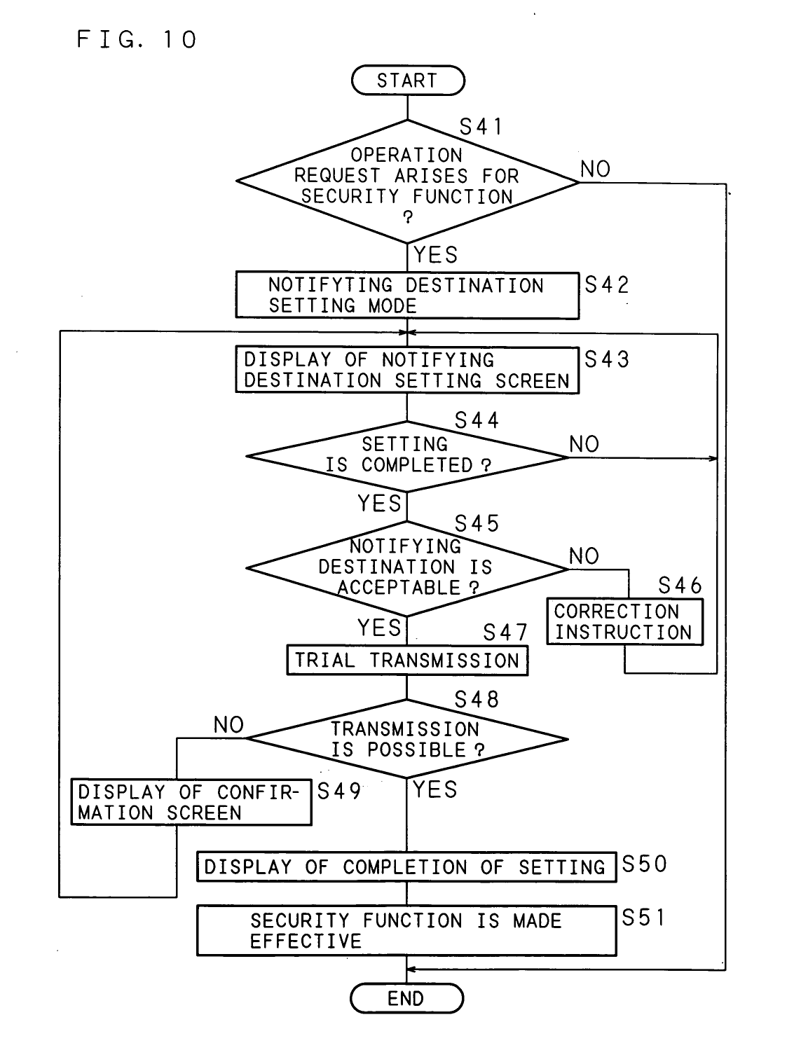

FIG. 10 is a flowchart explaining the procedure of the processing executed by the image forming apparatus 1 at turning on power. First, the CPU11 of the image forming apparatus 1 determines whether or not a prescribed operation by the device manager is received through the operation panel 15, to thereby determine whether or not there arises an operation request for the security function (step S41). When the CPU11 determines that there is no operation request for the security function (step S41: NO), the processing by this routine is terminated. Meanwhile, when a prescribed operation by the device manager is received through the operation panel 15, and the CPU11 determines that there arises the operation request for the security function (step S41: YES), the notifying destination setting mode to set the notifying destination of the warning information is started (step S42), and the notifying destination setting screen is displayed on the display part 15b of the operation panel 15 (step S43). The notifying destination setting screen displays to the effect that the security function is started, and to the effect that the contact address (electronic mail address) of the device manager should be set, and also displays the input button for calling the electronic mail input screen, and the determination button for registering the electronic mail address in the notifying destination managing table 14b.

Next, the CPU11 determines whether or not setting the electronic mail address of the device manager is completed by determining whether or not the determination button is depressed in the notifying destination setting screen (step S44). When setting the notifying destination is determined not to be completed (step S44: NO), the processing is returned to step S43, and when setting the notifying destination is determined to be completed (step S44: YES), the CPU11 determines whether or not the electronic mail address set in the notifying destination setting screen can be accepted as the notifying destination (step S45). When the CPU11 determines that the inputted address does not meet the format of n the electronic mail address, or the inputted address is a dummy electronic mail address, the CPU11 determines that the electronic mail address thus set can not be accepted as the notifying destination (S45: NO), and gives an instruction to correct the electronic mail address (step S46). Then, the processing is returned to step S43, the notifying destination setting screen is displayed again, and the re-setting of the electronic mail address is urged.

In step S45, when the CPU11 determines that the electronic mail address set in the notifying destination setting screen can be accepted as the notifying destination (step S45: YES), the trial transmission to the electronic mail address thus accepted is performed (step S45: YES), to determine whether or not such an mail address can be accepted as the transmitting destination (step S48). After the trial transmission, when it is determined that the error message is returned from the domain name server not shown, such an electronic mail address is determined not to be accepted as the transmitting destination (step S48: NO). Then, the confirmation screen of setting contents is displayed on the display part 15b (step S49), and the processing is returned to step S43. Then, by displaying the notifying destination setting screen again, the re-setting of the electronic mail address is urged.

Meanwhile, after the trial transmission, when the error message is not returned from the domain name server within a prescribed time, the electronic mail address already set is accepted as the transmitting destination (step S48: YES), and the display part 15b displays to the effect that setting of the electronic mail address is completed (step S50). Then, the CPU11 makes the security function effective (step S51).

Specifically, the CPU11 can be a device capable of executing data processing by the security program previously stored in the ROM13.

Note that explanation has been given in these embodiments 1 and 2 in such a way that when the security ROM is mounted, or when the security function is made effective, the notifying destination setting mode is started. However, when the security function is already in an operable state, the security program may move to the notifying destination setting mode when it is confirmed that the notifying destination is not set.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such meter and bounds thereof are therefore intended to be embraced by the claims.

1. A data protecting apparatus, comprising:
means for receiving data;
means for protecting the received data;
means for generating information to be reported to outside;
means for transmitting the generated information;
means for acquiring the information on a transmitting destination of the information, in the case for protecting of the data by said means; and
means for controlling the operation of said means so as to start the protection of the data, in the case for acquiring the information on the transmitting destination.

2. The data protecting apparatus of claim 1, further comprising;
means for verifying a presence of the transmitting destination, based on the information on the transmitting destination acquired by said means.

3. The data protecting apparatus of claim 2, comprising:
means for transmitting a request information to request a response to the transmitting destination;
means for receiving a response information transmitted to the request information; and
means for determining whether-or not the response information is received by said means, wherein based on a determination result of said means, the presence of the transmitting destination is verified.

4. The data protecting apparatus of claim 1, wherein the information on the transmitting destination is the information designating a transmission range.

5. The data protecting apparatus of claim 2, wherein the information on the transmitting destination is the information designating a transmission range.

6. The data protecting apparatus of claim 3, wherein the information on the transmitting destination is the information designating a transmission range.

7. The data protecting apparatus of claim 1, wherein the information on the transmitting destination is the information identifying the apparatus of the transmitting destination.

8. The data protecting apparatus of claim 2, wherein the information on the transmitting destination is the information identifying the apparatus of the transmitting destination.

9. The data protecting apparatus of claim 3, wherein the information on the transmitting destination is the information identifying the apparatus of the transmitting destination.

10. The data protecting apparatus of claim 1, wherein the information on the transmitting destination is an electronic mail address.

11. The data protecting apparatus of claim 2, wherein the information on the transmitting destination is an electronic mail address.

12. The data protecting apparatus of claim 3, wherein the information on the transmitting destination is an electronic mail address.

13. An image forming apparatus, comprising:
means for receiving image data;
means for forming an image on a sheet based on the received image data;
means for protecting the image data;
means for generating the information to be reported to outside;
means for transmitting the generated information;
means for acquiring the information on the transmitting destination of the information, in case for protecting the image data by said means; and
means for controlling an operation of said means so as to start the protection of the image data in case for acquiring the information on the transmitting destination.

14. A data protecting apparatus, comprising a processor capable of performing operations of:
receiving data;
protecting the received data;
generating information to be reported to outside;
transmitting the generated information;
acquiring the information on the transmitting destination of the information, in case that protecting the data is possible; and
starting protection of the data, in case that the information on the transmitting destination is acquired.

15. The data protecting apparatus of claim 14, wherein the operation further comprising an operation of;
verifying a presence of the transmitting destination, based on the information on the acquired transmitting destination.

16. The data protecting apparatus of claim 15, wherein the operation further comprising an operation of:
transmitting request information to request response to the transmitting destination;
receiving response data transmitted to the request information;
determining whether or not the response information is received; and
verifying a presence of the transmitting destination based on a determination result.

17. The data protecting apparatus of claim 14, wherein the information on the transmitting destination is the information designating a transmission range.

18. The data protecting apparatus of claim 15, wherein the information on the transmitting destination is the information designating a transmission range.

19. The data protecting apparatus of claim 16, wherein the information on the transmitting destination is the information designating a transmission range.

20. The data protecting apparatus of claim 14, wherein the information on the transmitting destination is the information identifying a apparatus of the transmitting destination.

21. The data protecting apparatus of claim 15, wherein the information on the transmitting destination is the information identifying a apparatus of the transmitting destination.

22. The data protecting apparatus of claim 16, wherein the information on the transmitting destination is the information identifying a apparatus of the transmitting destination.

23. The data protecting apparatus of claim 14, wherein the information on the transmitting destination is an electronic mail address.

24. The data protecting apparatus of claim 15, wherein the information on the transmitting destination is an electronic mail address.

25. The data protecting apparatus of claim 16, wherein the information on the transmitting destination is an electronic mail address.

26. An image forming apparatus, which forms an image on a sheet based on the received image data, comprising a processor capable of performing operations of:
receiving image data;
protecting the image data;
generating information to be reported to outside;
transmitting the generated information;
acquiring the information on the transmitting destination of the information, in case that protecting the image data is possible; and
starting the protection of the image data, in case that the information on the transmitting destination is acquired.
